(19) United States
(12) Patent Application Publication
(10) Pub. No.: US 2009/0110935 A1
(43) Pub. Date: Apr. 30, 2009

(54) CROSSLINKABLE FLUOROPOLYMER COMPOSITION AND USES THEREOF

(76) Inventors: William Christopher Lewis, Algonquin, IL (US); Marc W. F. Lewis, McHenry, IL (US); Helen Brain, Merseyside (GB); Leonard Harvey, Downingtown, PA (US); Kurt Mecray, Morgantown, PA (US); Michael Coates, Elverson, PA (US)

Correspondence Address: PAULEY PETERSEN & ERICKSON, 2800 WEST HIGGINS ROAD, SUITE 365, HOFFMAN ESTATES, IL, 60195, US

(21) Appl. No.: 12/251,913

(22) Filed: Oct. 15, 2008

Related U.S. Application Data
(60) Provisional application No. 60/998,938, filed on Oct. 15, 2007.

(51) Int. Cl. B32B 27/06; C08F 214/28; B05D 3/02; C08G 73/10

(52) U.S. Cl. 428/421; 526/254; 525/185; 427/385.5

(57) ABSTRACT

A fluoropolymer block copolymer containing a hydrofluorocarbon and a polyamide-based crosslinking agent crosslinked at a temperature above about 500° F. (about 260° C.). The crosslinked-block copolymer has compatibility with both non-hydrofluorocarbon-based fluoropolymers and engineered resins. Additionally, the block copolymer has unexpectedly high temperature stability, higher than each of the individual components.

### CROSS REFERENCE TO RELATED APPLICATION

This application claims the benefit of Provisional U.S. patent application Ser. No. 60/998,938, filed on 15 Oct. 2007. The co-pending Provisional U.S. patent application is hereby incorporated by reference herein in its entirety and is made a part hereof, including but not limited to those portions which specifically appear hereinafter.

### FIELD OF THE INVENTION

This invention relates generally to polymer compositions for use in coating systems, such as those which provide a coated substrate having a non-stick coating to which extraneous materials will not adhere. The polymer composition includes a crosslinked hydrofluorocarbon fluoropolymer, alone or with other resins or fluoropolymers such as polytetrafluoroethylene (PTFE).

### BACKGROUND OF THE INVENTION

The use of non-stick coating systems which are applied to a substrate in multiples layers has been known for many years. Typically, these coating systems include two layers consisting of a specially formulated primer and topcoat, but systems incorporating one or more intermediate midcoats are also known. The primers for such systems typically contain a heat resistant organic binder resin and one or more fluoropolymer resins, along with various opaque pigments and fillers. The midcoats contain mainly fluoropolymers with some amounts of opaque pigments, fillers and coalescing aids, while the topcoats are almost entirely composed of fluoropolymers. In such systems, the binder resin of the primer adheres to the substrate, while the fluoropolymer adheres to subsequent midcoat and/or topcoat layers. The binder and fluoropolymer of the primer are attached to one another via an essentially mechanical bond resulting from the mixing of the two components, followed by the curing of the primer after application to a substrate.

Further research has been directed to obtaining a multilayer non-stick coating system which exhibit both excellent primer-substrate adhesion and primer-topcoat adhesion, yet is resistant to separation failure at the interface between the binder and fluoropolymer components of the primer. There is continuing need for polymer compositions that improve the primer-substrate adhesion and primer-topcoat adhesion.

### SUMMARY OF THE INVENTION

A general object of the invention can be attained, at least in part, through a polymer composition comprising a hydrofluorocarbon fluoropolymer that is crosslinked with crosslinking agent at a temperature suitable to evoke crosslinking, such as above about 500° F. (about 260° C.). Exemplary hydrofluorocarbon fluoropolymers include fluoroelastomers or fluoroplastics capable of crosslinking. Exemplary crosslinking agents include amide-based or amino-based crosslinking agents.

The prior art does not crosslink a polyamide and/or a polyamine with a hydrofluorocarbon as in the present invention. It is the combination of these materials and the crosslinking of them together at the high temperature that provides the unexpected advantages of the polymer compositions of this invention. The operating temperatures of the resulting block copolymer or alloy are far superior to the individual components separately. The polymer composition of this invention provides improved adhesion properties to high-temperature, difficult to adhere surfaces such as glass, epoxy, and aramids, and further provides these surfaces with protection against hydrolysis and grease penetration.

The polymer compositions of this invention are also capable of operating at temperatures significantly above the operating temperatures of any of the individual components. This is significant in that it creates a material that has unique adhesion and temperature capabilities. The polymer compositions of this invention maintain mechanical and adhesion properties, even at operating temperatures as high as 450° F. Those skilled in the art will understand the significance of this capability, considering that the mechanical strengths of any of the individual components operating at this temperature would be significantly reduced.

The crosslinked polymer composition of this invention is believed to chemically bond to the hydroxyl groups on, for example, a substrate filament/yarn surfaces. It has been found that by removing the hydroxyl groups through a chemical bonding mechanism, the wicking action throughout the yarn is substantially slowed. By slowing this wicking phenomenon, substantial increased service life of the fluoropolymer coated substrate can be achieved.

The invention further includes a substrate coated with the polymer composition and a method for coating such a substrate. The polymer composition is applied to the substrate as a mixture of the polymer composition components (i.e., the hydrofluorocarbon and the crosslinking agent, and optional additional fluoropolymers and/or engineered resins), or as separate layers of the polymer composition components. The substrate with the applied polymer composition is heated to a crosslinking temperature, such as above about 500° F. (about 260° C.), to crosslink the applied hydrofluorocarbon fluoropolymer with the applied crosslinking agent. In embodiments where the polymer composition is applied in multiple layers, the separate layers can be dried at lower temperatures to remove solvents before the next layer is applied. The final high temperature sintering of the polymer composition provides the crosslinking which results in the improved properties of the polymer composition coating of this invention.

Other objects and advantages will be apparent to those skilled in the art from the following detailed description taken in conjunction with the appended claims and drawings.

### BRIEF DESCRIPTION OF THE DRAWINGS

FIG. 1 is a schematic illustration showing a coated substrate according to one embodiment of this invention.

FIG. 2 is a schematic illustration showing a coated substrate according to another embodiment of this invention, including a midcoat and a topcoat.

### DETAILED DESCRIPTION OF THE INVENTION

The present invention provides polymer compositions. The invention is particularly directed to a polymer composition including a hydrofluorocarbon fluoropolymer that is crosslinked using a crosslinking agent. The invention is further directed to use of the crosslinked polymer material to form a resulting blend or alloy, and its unique mechanical and adhesive properties. In the composition of one embodiment of this invention, the hydrofluorocarbon fluoropolymer, the crosslinking agent, and optionally another polymer material are combined in a single batch or solution and then the materials brought to a sufficient temperature to induce a crosslinking reaction. These materials, when combined in this manner, can be used as an adhesion promoter for non-hydrofluorocarbon based fluoropolymers such as, polytetrafluoroethylene (PTFE), to substrates; or as a standalone product in the form of a cast film; or as a low-surface energy coating that adheres very well to hydroxyl containing composites such as, polyamide or bisphenol A.

The composition of one embodiment of the present invention is formed by a crosslinking reaction that occurs when a hydrofluorocarbon containing fluoropolymer is combined with a crosslinking agent, such as amide-based and/or amino-based crosslinking agent, and brought well above the typical operating temperatures of the component material, e.g., to about 500° F. (260° C.). It also has been found that the crosslinking reaction occurs much faster, the higher the crosslinking temperature. For instance, in one embodiment, the cure temperature at 750° F. is less than 10 seconds, where the crosslinking time is longer at lower temperatures. The result of the crosslinking is a block copolymer of the hydrofluorocarbon containing fluoropolymer and the crosslinking agent.

Exemplary hydrofluorocarbon-containing fluoropolymers exist as homopolymers, e.g., polyvinylidene fluoride (PVDF) (PVF2) and polyvinyl fluoride (PVF), or copolymers, such as dipolymers, e.g., HALAR® copolymers of ethylene and chlorotrifluoroethylene (ECTFE), ethylene tetrafluoroethylene (ETFE), vinylidene fluoride (VF2), and vinylidene fluoride with hexafluoropropylene, and terpolymers, e.g., fluoroelastomers or fluoroplastics capable of crosslinking. Additionally, this group would include monomers containing alkoxyvinylidene groups. In one embodiment of this invention, the hydrofluorocarbon-containing fluoropolymer includes a combination of tetrafluoroethylene (TFE), hexafluoropropylene (HFP), and vinylidene fluoride (VDF) units. The hydrofluorocarbon fluoropolymer can be, for example, a copolymer of vinylidene fluoride and hexafluoropropylene; a terpolymer of tetrafluoroethylene, hexafluoropropylene, and vinylidene fluoride; a terpolymer of ethylene, hexafluoropropylene, and vinylidene fluoride; and a terpolymer of perfluoroalkoxy, tetrafluoroethylene and hexafluoropropylene; or combinations thereof.

An exemplary hydrofluorocarbon fluoropolymer is a fluoropolymer terpolymer including three repeating monomer units, specifically, each of tetrafluoroethylene (TFE), hexafluoropropylene (HFP), and vinylidene fluoride (VDF) units. Fluoropolymer copolymers including TFE, HFP, and VDF monomers are collectively referred to as “THV.” One suitable family of THV terpolymer is sold under the name DYNEON, available from Dyneon LLC, Oakdale, Minn. Homologs of THV or any fluoropolymer having an acidic proton are also useful in creating the composition of this invention.

As mentioned above, the crosslinking agent can be an amide-based and/or amino-based crosslinking agent. An amide-based or amino-based crosslinking agent desirable includes at least one functional group selected from amide and amine functional groups. Exemplary crosslinking agents include polyaminoamides, polyamines, polyamides, amino silanes, amide silanes, or combinations thereof.

In one embodiment of this invention, preferred crosslinking, or curing, agents include reactive polyamide materials. Exemplary polyamide materials for use in this invention include polyaminoamide materials such as, without limitation, VERSAMID, available from Cognis, or POLYCUP, available from Hercules Ventures. However, polyaminoamide adhesion can be further enhanced through the addition of polyamine materials such as JEFFAMINE, available from Huntsman International, or polyamide-based curing agents can be combined with polyamine-curing agents to achieve similar results.

Unlike the prior art, the current invention is not an interface material for bonding a hydrofluorocarbon to a low temperature material such as nylon, but rather a block copolymer that is created by crosslinking the hydrofluorocarbon with, for example, a polyaminoamide material at a temperature above about 500° F. (about 260° C.). The block copolymer of this invention does have improved adhesive properties, but also excellent temperature, release, and mechanical properties created during the crosslinking reaction.

The crosslinking reaction of this invention results in changes in properties for the hydrofluorocarbon containing fluoropolymer, and is also generally evidenced by a change in color from the typical yellowish material (when dried and cured) to the black crosslinked material. Further, particularly when combined with PTFE as discussed further below, the polymer composition of this invention has one thermal decomposition (TGA) point that is at, or above all components in the composite, for example at greater than about 450° C., and more desirably above about 500° C.

### Color Changes and Conditions:

| | |
|---|---|
| THV + PTFE: | Light tan color |
| PTFE + VERSAMID: | Light tan/brown |
| THV + VERSAMID + PTFE @ 475° F. - 10 minutes: | Light tan/brown |
| THV + VERSAMID + PTFE @ 750° F. - 20 seconds: | Black |
| THV + VERSAMID @ 450° F. - 10 minutes: | Light tan/brown |
| THV + VERSAMID @ 525° F. - 10 minutes: | Medium Brown |
| THV + VERSAMID @ 750° F. - 20 seconds: | Black |

In the block copolymer of this invention, the polyaminoamide is chemically bonded to the THV, and connects two chains of THV, and desirably many polyaminoamides connect many chains of THV together to create the block copolymer. Without intending to be bound by theory, it is believed that during the curing process the VDF of the THV is attacked, whereby the vinyl combines with the polyaminoamide to create a high-temperature resistant nylon-like material. Once cooled after the crosslinking reaction of this invention, the polyaminoamide modified THV block copolymer of this invention is much tougher and has higher temperature resistant than the original THV. The crosslinked block copolymer has the toughness and abrasion resistance of nylon, and (unlike THV) the release properties of a highly fluorinated fluoropolymer.

The polymer compositions of this invention can vary in the amount of each component, depending on need. In one embodiment of this invention the polymer composition includes about 5% by weight to about 70% by weight of the crosslinking agent. The polymer compositions of this invention can also include other materials, such as fillers and/or pigments. Exemplary filler materials for use in the compositions of this invention include inorganic metal oxides and metal oxide complexes, such as titanium dioxide, chromium dioxide, zinc oxide, iron oxide, aluminum oxide, silicon oxides, zirconium oxide, and mixtures thereof; silicates, such as aluminum silicate, magnesium aluminum silicate, and mixtures thereof; and inorganic carbides and nitrides, such as silicon carbide, titanium carbide, silicon nitride, titanium nitride, and boron nitride, and mixtures thereof. Pigments may include ultramarine blue zeolite, channel black, carbon black, and mixtures thereof.

In one embodiment of this invention, the polymer composition includes a fluoropolymer that is not a crosslinkable hydrofluorocarbon fluoropolymer (also referred to as a non-hydrofluorocarbon fluoropolymer) that is combined with the hydrofluorocarbon fluoropolymer before the crosslinking. Non-hydrofluorocarbon fluoropolymers include materials such as polytetrafluoroethylene (PTFE), modified PTFE, fluorinated ethylene propylene, perfluoroalkoxy copolymer (PFA), modified perfluoroalkoxy copolymer (MFA), fluoroplastic, or copolymers or combinations thereof. The polymer compositions of this invention can include various amounts of one or more non-hydrofluorocarbon fluoropolymers. In one embodiment of this invention, the polymer composition includes about 1.5% by weight to about 95% by weight of the hydrofluorocarbon fluoropolymer, about 0.75% to about 50% by weight of the crosslinking agent, and up to 97.5% of the fluoropolymer that is not a crosslinkable hydrofluorocarbon fluoropolymer.

Without wishing to be bound by theory, the polymer composition including the hydrofluorocarbon fluoropolymer, the crosslinking agent, and the fluoropolymer that is not a crosslinkable hydrofluorocarbon fluoropolymer is, upon heating and crosslinking, properly considered a blend of the crosslinked hydrofluorocarbon and the non-hydrofluorocarbon fluoropolymer. The crosslinked polymer composition results in a mechanical bond between the crosslinked hydrofluorocarbon and the non-hydrofluorocarbon fluoropolymer. The crosslinked polymer composition of this invention exhibits excellent substrate adhesion, as well as adhesion to additional polymer overcoatings. The polymer composition exhibits excellent adhesion to smooth substrates, and may include a high level of fillers, such as those described above, to provide increased damage resistance without compromising the above benefits.

The polymer composition blend of this invention can be used to provide an alloy or alloy-like material with a non-hydrofluorocarbon fluoropolymer such as PTFE. In this combination, the polymer composition is crosslinked to create a material that is useful for bonding PTFE to various substrates, such as metal and epoxy, where otherwise PTFE is known to have little or no adhesion. Again, without wishing to be bound by theory, the alloy of this invention creates a mechanical bond between the PTFE and the substrate.

In another embodiment of this invention, the polymer composition includes an engineered resin combined with the hydrofluorocarbon fluoropolymer and the crosslinking agent before the crosslinking. The engineered resin can be included in combination with or as an alternative to the non-hydrofluorocarbon fluoropolymer. Exemplary engineered resins for use in the compositions of this invention include thermoplastic or thermoset materials, particularly those that are capable of withstanding the crosslinking temperature, such as, without limitation, epoxies, silicones, liquid crystal polyesters, polyimides, polyamideimides, polyetheretherketones, polyethersulfones, polysulfides, polysulfonne, polyphenylensulfide, and copolymers or combinations thereof. The polymer compositions of this invention can include various amounts of one or more engineered resin. In one embodiment of this invention, the polymer composition includes about 2.5% by weight to about 90% by weight of the hydrofluorocarbon fluoropolymer, about 0.75% to about 40% by weight of the crosslinking agent, and up to 80% of the engineered resin.

In one embodiment of this invention, the combination of a crosslinking agent, a hydrofluorocarbon, a non-hydrofluorocarbon containing fluoropolymer, and a non-fluorine containing thermoplastic or thermoset material are mixed at a sufficient temperature to crosslink the mixture to create a further alloy-like blend. The crosslinked hydrofluorocarbon mechanically bonds the engineered resin and/or non-hydrofluorocarbon containing fluoropolymer to each other as well as substrates and overcoat polymer layers.

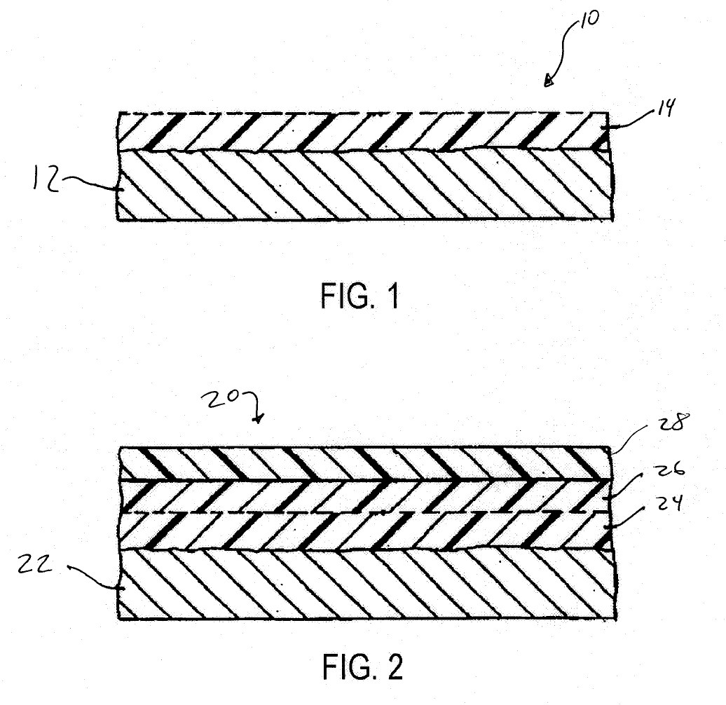

The polymer compositions of this invention are useful as substrate coatings. FIG. 1 illustrates a coated substrate 10, having substrate 12 coated with polymer layer 14 including a polymer composition of this invention. The substrate 14 can be rigid or flexible, and fibrous or nonfibrous. The substrate can also take any form, such as belts, films, foils, wires, hoses, fabrics, filaments, yarns, tapes, composites, and/or metal, plastic, or glass sheets. Exemplary substrate materials typically capable of withstanding the temperatures of the crosslinking reaction include, for example, fiberglass, glass, polyester, nylon, metal, ceramics, composites, aramids, or other substrates that would not decompose during fast cure, high temperature crosslinking of the polymer composition. In one embodiment, the polymer composition can be used as a coating for Kevlar materials, due to the ability to bond with PTFE. Thus, the block copolymer or alloy can coat Kevlar clothing or Kevlar conveyor belts. In addition to coatings, the block copolymers and alloys of this invention are useful in making cast films or for injection molding applications.

FIG. 2 illustrates a coated substrate 20, having substrate 22 coated with polymer layer 24 including a polymer composition of this invention. In FIG. 2, the polymer layer 24 is coated with an optional overcoat or midcoat 26 and a topcoat 28. The midcoat 26 and overcoat 26 can be a further layer of a polymer composition of this invention, or can be layers of other polymer materials, such as fluoropolymers or engineered resins.

The polymer composition may be applied to a wide variety of substrates, including but not limited to, metal cookware, printer and photocopier rollers, building materials, industrial tools, and high temperature resistant fabrics such as fiberglass and woven polyaramids. Other more particular uses include anti-icing surface coatings and/or low coefficient of friction coating for exteriors of composites such as, aircraft wings, boat hulls and windmills; anti-fouling surface coatings for ships; water and dirt repellent surfaces for car and architectural glass, including interiors of showers; low-cost single coat system for providing non-stick surfaces to cookware, foils, metal utensils; additives for composites to provide longer flex life; intermediate boundary layers between fluoropolymers and engineered resins; and anti-wicking surface treatments for composites.

The invention further contemplates a method of coating a substrate. The individual components of the polymer composition, e.g., the hydrofluorocarbon fluoropolymer and the crosslinking agent, and the optional additional non-hydrofluorocarbon fluoropolymer and/or engineered resin, can be applied to the substrate in a mixture, or in separate applications. In one embodiment of this invention, the crosslinking agent or the hydrofluorocarbon fluoropolymer is applied as a coating layer to the substrate and the other of the crosslinking agent or the hydrofluorocarbon fluoropolymer is applied as a further coating layer to the applied coating layer. The materials can be applied in different forms as well. For example, all components can be applied as a dispersion, or the hydrofluorocarbon fluoropolymer can be applied as a powder to the substrate and the crosslinking agent is applied as a liquid dispersion to the powder. The powder can also be layered on an applied dispersion.

The non-hydrofluorocarbon fluoropolymer and/or engineered resin can be applied in a mixture with one or both of the hydrofluorocarbon and the crosslinking agent, in separate layers, or both. The engineered resin, the non-hydrofluorocarbon fluoropolymer, or the combination thereof can be applied to the substrate in a polymer mixture with the crosslinking agent, the hydrofluorocarbon fluoropolymer, or both the crosslinking agent and the hydrofluorocarbon fluoropolymer. In another embodiment, the engineered resin, the non-hydrofluorocarbon fluoropolymer, or a combination thereof is applied as an overcoat layer to the applied crosslinking agent and/or the applied hydrofluorocarbon fluoropolymer. Alternatively, the crosslinking agent and the hydrofluorocarbon fluoropolymer can be applied as one or more overcoat layers to the applied engineered resin, the non-hydrofluorocarbon fluoropolymer, and/or the combination thereof. When individual components of the polymer composition are applied to a substrate in more than one layer before crosslinking, the individual layers are desirably dried, such as before each further layer application, at a temperature below the crosslinking temperature to remove solvent.

The coated substrate is heated to a temperature above about 500° F. (about 260° C.) to crosslink the applied hydrofluorocarbon fluoropolymer with the applied crosslinking agent. The heating can be accomplished by any suitable means, such as heating by infrared radiation, hot air, microwave, or combinations thereof. The heat source can be an oven or a heat press, desirably having a gap set so as to not press a substrate fabric. Infrared radiation is particularly desirable, as the necessary temperature is reached relatively quickly. The curing time for the crosslinking reaction may depend on the particular components and how the components are applied, but often the time for obtaining crosslinking at such high temperatures is less than one minute. Conventional cure accelerators can be added to the polymer composition to further promote the curing step.

Midcoats and overcoats can be applied before or after the crosslinking steps. In one embodiment, a polymer composition is crosslinked to adhere to the substrate, and additional polymer coatings are applied to the crosslinked polymer composition and cured using conventional curing processes. The polymer compositions are thus particularly useful as an adhesion promoting primer layer for multi-layer surface coatings, such as for cookware and high temperature conveyor belts.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

To demonstrate aspects of this invention, fiberglass fabrics were coated as described in Table 1 below. The glass fabric substrates were 7628 fabric (Burlington Glass Fabrics) with a 517 finish. Samples 1-11 were additionally treated with silane before coating. Samples 6-11 each included 20% polyamideimide (PAI), and Samples 9-11 each included 1.5% zinc as a cure accelerator. Versamid 140 was used for all Samples.

For preparing each Sample, each coating layer was applied by hand using a dip or brush application of the coating material, the coating layers were dried with a hand dryer, and the coating was then fully dried in an oven at 450° F. The coating was then fused at 750° F. on at heated press with the gap set so as to not press the fabric. The Control base coating composition contained 40% solids, the base coating compositions for Samples 6-11 each contained 33% solids, and the Sample 12 base coating composition contained 20% solids.

TABLE 1

| | Base Coat | Mid | Top | BC | BC | BC | BC | # BC |
|---|---|---|---|---|---|---|---|---|
| Sample | (BC) | Coat | Coat | THV | PTFE | Versamid | PAI | Passes |
| Control | PTFE | PTFE | PTFE | 0.00% | 100.00% | 0.00% | 0.00% | |
| 1 | THV/PTFE | PTFE | PTFE | 2.50% | 95.00% | 2.50% | 0.00% | 2 |
| 2 | THV/PTFE | PTFE | PTFE | 2.50% | 92.50% | 5.00% | 0.00% | 2 |
| 3 | THV/PTFE | PTFE | PTFE | 5.00% | 92.50% | 2.50% | 0.00% | 2 |
| 4 | THV/PTFE | PTFE | PTFE | 10.00% | 90.00% | 0.00% | 0.00% | 2 |
| 5 | THV/PTFE | PTFE | PTFE | 10.00% | 85.00% | 5.00% | 0.00% | 2 |
| 6 | PAI/THV/PTFE | PTFE | PTFE | 5.00% | 75.00% | 0.00% | 20.00% | 2 |
| 7 | PAI/THV/PTFE | PTFE | PTFE | 10.00% | 70.00% | 0.00% | 20.00% | 2 |
| 8 | PAI/THV/PTFE | PTFE | PTFE | 20.00% | 60.00% | 0.00% | 20.00% | 2 |
| 9 | PAI/THV/PTFE | PTFE | PTFE | 20.00% | 53.50% | 0.00% | 20.00% | 2 |
| 10 | PAI/THV/PTFE | PTFE | PTFE | 20.00% | 53.50% | 5.00% | 20.00% | 2 |
| 11 | PAI/THV/PTFE | PTFE | PTFE | 5.00% | 68.50% | 5.00% | 20.00% | 2 |
| 12 | THV/PTFE | PTFE | PTFE | 10.00% | 85.00% | 5.00% | 0.00% | 1 |

Table 2 includes test data of the Samples 1-12 of Table 1. The Adhesion testing was performed according to ASTM D751 and the Tear testing was performed according to ASTM D1424.

TABLE 2

| | | Adhesive | Adhesive | Tear - | Tear - |
|---|---|---|---|---|---|
| | Adhesive | Strength | Strength | Warp | Fill |
| Sample | Failure | Peak | Avg. | (Avg.) | (Avg.) |
| Control | Glass | 3.86 | 3.49 | 3.80 | 2.11 |
| 1 | Glass | 1.43 | 1.28 | 9.86 | 6.62 |
| 2 | Glass | 1.61 | 1.19 | 11.69 | 11.27 |
| 3 | Glass | 7.64 | 4.66 | 3.52 | 1.97 |
| 4 | Glass | 3.44 | 2.46 | 8.31 | 4.79 |
| 5 | Glass | 6.96 | 5.82 | 5.07 | 2.25 |
| 6 | Intracoat | 4.69 | 3.16 | 6.06 | 3.38 |
| 7 | Intracoat | 2.96 | 2.68 | 5.77 | 4.08 |
| 8 | Intracoat | 2.02 | 1.74 | 6.62 | 2.96 |
| 9 | Intracoat | 1.85 | 1.41 | 8.03 | 3.94 |
| 10 | Intracoat | 5.22 | 4.72 | 3.80 | 2.11 |
| 11 | Intracoat | 7.44 | 4.94 | 2.25 | 3.52 |
| 12 | Glass | 14.42 | 12.12 | 3.10 | 2.25 |

Without wishing to be bound by theory, the results appear to indicate that the proportions of THV and Versamid were relevant for these Samples. Samples 1 and 2, having lower THV to Versamid ratios, provided lower adhesion, possibly due to having less THV available for crosslinking. Samples 3 and 5 demonstrated increased adhesion (almost double), and had a 2:1 THV to Versamid ratio. Applicants have found that around a 2:1 ratio of hydrofluorocarbon to crosslinker is often a desirable ratio, particularly where there is no engineered resin included in the composition.

Samples 10 and 11 also demonstrated increased adhesion over Samples 6-8, which did not benefit from crosslinking according to this invention. The much higher adhesion of Sample 12 can likely be explained in part by the lower percent solids (lower viscosity) and the increased openness of the glass substrate without the silane coating, thereby allowing for increased penetration of the composition into the glass substrate.

Table 3 includes the decomposition temperature for the base coatings of Samples 1-5, as well as a polyamideimide (PAI) polymer, THV 340 available from Dyneon LLC, and VERSAMID alone.

TABLE 3

| | Decomposition Temp |
|---|---|
| Sample | (TGA) (° C.) (Onset) |
| PAI D2376 | 444.44 |
| THV 340 | 451.48 |
| Versamid | 406.21 |
| Sample 1 | 501.67 |
| Sample 1 | 503.19 |
| Sample 2 | 500.87 |
| Sample 2 | 500.41 |
| Sample 3 | 501.61 |
| Sample 4 | 457.02; 496.63 |
| Sample 5 | 502.32 |

As shown in Table 3, the individual components (Versamid, THV 340, and PAI 2376) with the belting material showed significantly lower decomposition temperatures as compared with the polymer compositions of Samples 1-3 and 5. This indicates that a more thermally stable end-product was produced. Decomposition temperatures of the materials of Samples 1-3 and 5 showed at least about a 50 degree increase in temperature stability as opposed to the individual components alone.

Sample 4 was not a polymer composition of this invention, and contained 90% PTFE/10% THV (the sample contained no Versamid). Sample 4 was the only material with a two stage decomposition, which makes sense since it had no crosslinking agent. What is seen is the decomposition of the THV and then the PTFE at the higher temperature. Samples 1-3 and 5 showed a one-step weight loss, which would indicate a more homogeneous material composition (alloy) in which the individual components formed a higher temperature stable end-product.

### Wicking Test

Two additional samples using 2116 substrates were coated to a 5 mil thickness.
Sample 13: 2116 coated to 5 mil using PTFE only (Industry Standard Coating)
Sample 14: 2116 coated to 5 mil in the following manner:
   Pass 1: 15% Solids Coating (10% THV, 5% Versamid, 85% PTFE) Dry Material Below Sintering Temp, Sinter for 1 minute at 371° C. (700° F.).
   Pass 2: 15% Solids Coating (10% THV, 5% Versamid, 85% PTFE) Dry Material Below Sintering Temp, Sinter for 1 minute at 371° C. (700° F.).
   Pass 3-6: 45% Solids PTFE Coating; Dry Material Below Sintering Temp, Sinter for 1 minute at 371° C. (700° F.).

A hole was punched in the center of each coated sample. The material was then immersed in ground nut oil with the center hole immersed in the oil, with the exposed edges of each sample outside of the oil. The samples were immersed for one week at 170° C. (338° F.) and checked daily.

### Wicking Test Results

### Day 1:

Sample 13: No noticeable changes.
Sample 14: No noticeable changes.

### Day 2:

Sample 13: Coating was noticeably softened around exposed center hole and extending outward. Oil ingress in coating and yarns is noticeable, with wicking almost completely soaking substrate. Even substrate outside of oil had noticeable oil in yarns. Coating around immersed hole was easily removed from substrate.
Sample 14: No noticeable wicking. Coating remained hard and fully adhered to substrate. Could not remove coating from substrate and in fact, destroyed substrate while removing coating.

### Day 7:

Sample 13: Substrate was fully saturated with oil. Fluoropolymer coating was bubbled and peeled of substrate. When worked under microscope, the coating peeled of the substrate and the coating itself was saturated with oil.
Sample 14: Oil ingress was observed, but material was not fully saturated, as Sample 13. In fact, there was a noticeable visual difference between materials in wicking penetration. Additionally, unlike Sample 13, the coating could not be removed from surface of the substrate without destroying the substrate.

Thus, the invention provides a polymer composition that can be used to coat substrates. The polymer composition is an effective adhesion promoter for fluoropolymer coatings of surfaces such as metal and glass. The block copolymer provided by this polymer composition, when applied to substrates such as, fiberglass, metal, or aramid, results in an exhibit exceptionally strong, water-resistant bond. When included as a component in a coating, the combined composite exhibits exceptionally strong intracoat adhesion. When cast as a film and cured, the resulting film is very tough and has excellent mechanical properties, while maintaining its release characteristics. Lastly, the components in the block copolymer can further be “alloyed” with non-hydrofluorocarbon-based fluoropolymers that have all the capabilities of the initial alloyed material, except these materials have lower surface energy and better release.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A polymer composition, comprising a hydrofluorocarbon fluoropolymer that is crosslinked with at least one of an amide-based or amino-based crosslinking agent at a temperature above about 500° F. (about 260° C.).

2. The polymer composition according to claim 1, wherein the hydrofluorocarbon fluoropolymer comprises a fluoroelastomer or a fluoroplastic capable of crosslinking.

3. The polymer composition according to claim 1, wherein the hydrofluorocarbon fluoropolymer comprises a copolymer of vinylidene fluoride and hexafluoropropylene; a terpolymer of tetrafluoroethylene, hexafluoropropylene, and vinylidene fluoride; a terpolymer of ethylene, hexafluoropropylene, and vinylidene fluoride; and a terpolymer of perfluoroalkoxy, tetrafluoroethylene and hexafluoropropylene; or combinations of.

4. The polymer composition according to claim 1, wherein the crosslinking agent is selected from the group consisting of a polyaminoamide, a polyamine, a polyamide, amino silane, amide silane, or combinations thereof.

5. The polymer composition according to claim 1, wherein the polymer composition comprises about 5% by weight to about 70% by weight of the crosslinking agent.

6. The polymer composition according to claim 1, further comprising a fluoropolymer that is not a crosslinkable hydrofluorocarbon fluoropolymer, wherein the fluoropolymer is combined with the hydrofluorocarbon fluoropolymer before the crosslinking.

7. The polymer composition according to claim 6, wherein the fluoropolymer that is not a crosslinkable hydrofluorocarbon fluoropolymer comprises a polytetrafluoroethylene (PTFE), a modified PTFE, a fluorinated ethylene propylene, a perfluoroalkoxy copolymer (PFA), a modified perfluoroalkoxy copolymer (MFA), a fluoroplastic, or copolymers or combinations thereof.

8. The polymer composition according to claim 6, wherein the polymer composition comprises about 1.5% by weight to about 95% by weight of the hydrofluorocarbon fluoropolymer, about 0.75% to about 50% by weight of the crosslinking agent, and up to 97.5% of the fluoropolymer that is not a crosslinkable hydrofluorocarbon fluoropolymer.

9. The polymer composition according to claim 1, further comprising an engineered resin, wherein the engineered resin is combined with the hydrofluorocarbon fluoropolymer and the crosslinking agent before the crosslinking.

10. The polymer composition according to claim 9, wherein the engineered resin is selected from the group consisting of an epoxy, a polyimide, a polyamideimide, a polyetheretherketone, polyethersulfone, polysulfides, polysulfonne, polyphenylensulfide, and copolymers or combinations thereof.

11. The polymer composition according to claim 9, wherein the polymer composition comprises about 2.5% by weight to about 90% by weight of the hydrofluorocarbon fluoropolymer, about 0.75% to about 40% by weight of the crosslinking agent, and up to 80% of the engineered resin.

12. The polymer composition according to claim 9, further comprising a fluoropolymer that is not a crosslinkable hydrofluorocarbon fluoropolymer, wherein the fluoropolymer and the engineered resin are combined with the hydrofluorocarbon fluoropolymer and the crosslinking agent before crosslinking.

13. The polymer composition according to claim 12, comprising an alloy of at least the fluoropolymer that is not a crosslinkable hydrofluorocarbon fluoropolymer, the hydrofluorocarbon fluoropolymer, and the crosslinking agent

14. A substrate coated with the polymer composition of claim 1.

15. The substrate according to claim 14, wherein the substrate is a flexible substrate selected from the group consisting of a belt, film, foil, wire, hose, fabric, filament, yarn, tape, composite, or combinations thereof.

16. The substrate according to claim 14, wherein the substrate is a rigid substrate comprising a material selected from the group consisting of metal, glass, plastic, composite, or combinations thereof.

17. A method of coating a substrate, comprising:
applying a hydrofluorocarbon fluoropolymer to the substrate;
applying at least one of an amide-based or amino-based crosslinking agent to the substrate; and
heating the substrate to a temperature above about 500° F. (about 260° C.) to crosslink the applied hydrofluorocarbon fluoropolymer with the applied crosslinking agent.

18. The method according to claim 17, wherein one of the crosslinking agent or the hydrofluorocarbon fluoropolymer is applied as a coating layer to the substrate and an other of the crosslinking agent or the hydrofluorocarbon fluoropolymer is applied as a further coating layer to the applied coating layer before the heating.

19. The method according to claim 17, wherein the hydrofluorocarbon fluoropolymer is applied as a powder to the substrate and the crosslinking agent is applied as a liquid dispersion to the powder.

20. The method according to claim 17, wherein the crosslinking agent and the hydrofluorocarbon fluoropolymer are applied as a polymer mixture.

21. The method according to claim 20, wherein the polymer mixture further comprises a fluoropolymer that is not a crosslinkable hydrofluorocarbon fluoropolymer, an engineered resin, or a combination thereof.

22. The method according to claim 17, further comprising applying a cure accelerator.

23. The method according to claim 17, wherein the heating the substrate comprises heating by infrared radiation, hot air, microwave, or combinations thereof.

24. The method according to claim 17, further comprising:
applying to the substrate an engineered resin, a fluoropolymer that is not a crosslinkable hydrofluorocarbon fluoropolymer, or a combination thereof; and
forming an alloy of at least the hydrofluorocarbon fluoropolymer, the crosslinking agent, and the fluoropolymer that is not a crosslinkable hydrofluorocarbon fluoropolymer, wherein the alloy adheres to the substrate.

25. The method according to claim 24, wherein the engineered resin, the fluoropolymer that is not a crosslinkable hydrofluorocarbon fluoropolymer, or the combination thereof is applied as an overcoat layer to the applied crosslinking agent or the applied hydrofluorocarbon fluoropolymer.

26. The method according to claim 24, wherein the crosslinking agent and the hydrofluorocarbon fluoropolymer is applied as an overcoat layer to the applied engineered resin, the fluoropolymer that is not a crosslinkable hydrofluorocarbon fluoropolymer, or the combination thereof.

27. The method according to claim 24, wherein the engineered resin, the fluoropolymer that is not a crosslinkable hydrofluorocarbon fluoropolymer, or the combination thereof is applied to the substrate before heating the substrate to a temperature above about 500° F. (about 260° C.).

28. The method according to claim 27, wherein the engineered resin, the fluoropolymer that is not a crosslinkable hydrofluorocarbon fluoropolymer, or the combination thereof is applied in a polymer mixture with the crosslinking agent, the hydrofluorocarbon fluoropolymer, or both the crosslinking agent and the hydrofluorocarbon fluoropolymer.
